(19) United States
(12) Patent Application Publication
(10) Pub. No.: US 2003/0152668 A1
(43) Pub. Date: Aug. 14, 2003

(54) Puzzle candy

(76) Inventor: Justin C. Griffin, Pleasant Grove, UT (US)

Correspondence Address: Angus C. Fox, III, 4093 N. Imperial Way, Provo, UT, 84604-5386, US

(21) Appl. No.: 10/360,907

(22) Filed: Feb. 6, 2003

Related U.S. Application Data
(63) Continuation-in-part of application No. 10/077,743, filed on Feb. 14, 2002, now abandoned.

(51) Int. Cl. A23G 1/00

(52) U.S. Cl. 426/104

(57) ABSTRACT

Puzzle candy pieces, that may assembled in a consumer's mouth to form structures of increased complexity, by manipulation of the pieces using the tongue, in combination with the walls and roof of the mouth, may take numerous different shapes. One type includes an annular piece and either a ball or plug insertable through the annular piece. Another includes candy bolts and nuts. The nut is manipulated and rotated in order to engage the bolt. Another includes a sardine-can-shaped base member into which a pair of plugs may be inserted. Yet another includes a female piece having a cross-shaped receptacle and a cross-shaped male piece which assemble to form a cubic shape. Still another is a dumbbell assembly formed from two identical end pieces which mate to a shaft piece. Finally, another includes a candy spring and candy doughnut which can be threaded onto the spring.

This is a continuation-in-part of application Ser. No. 10/077,743, filed Feb. 14, 2002, which is now abandoned.

### BACKGROUND OF THE INVENTION

1. Field of the Invention

This invention relates both to candy and three-dimensional puzzles.

2. Description of the Prior Art

In the last 100 years, food for human consumption has undergone dramatic changes in preparation, processing, nutrition, appearance and packaging. Though some may claim that the ready availability of food and drinks of all types has transformed the U.S. into a nation of gluttons, it is nonetheless a maxim that clever packaging has increased consumption of food and drinks more than has improved nutrition.

The primary definition of the word “puzzle”, according to The Random House Dictionary of the English Language (©1983) is “a toy or other contrivance designed to amuse by presenting difficulties to be solved by ingenuity or patient effort.” Puzzles of many different types have delighted members of the human race through the ages. Rubik's Cube, jigsaw puzzles, three-dimensional wood block puzzles, and wire puzzles are just a few of the many different types of available puzzles.

A number of food puzzles have been patented over the years. One of the earliest is U.S. Pat. No. 986,286, which issued to Charles F. Hartmann on Mar. 7, 1911. A Baking Apparatus is disclosed, which serves both as a baking pan and as a cutting die for cookie dough or the like. The die or cutting portion is apparently removable from the underlying pan or baking sheet, with the dough being placed on the sheet and then cut with the die. The die, however, remains in place during baking, and serves to preclude the spreading of the cut pieces during baking in order to provide accurate assembly of the pieces.

U.S. Pat. No. 2,775,523, which issued to Madelyne L. Green on Dec. 25, 1956, discloses a Decorative House formed of a series of interlocking baking pans. The dough or batter is formed within each of the pans, and the food is cooked within the pans. The pans are then assembled with the baked goods disposed to the outside, to form the appearance of a gingerbread house or the like. The baking pan thus does not serve to cut the dough or the like, but rather serves as a baking utensil and as a structural element for the completed three dimensional structure. The present invention operates strictly as a cutting device for the dough or batter, and is not intended to be heated during baking operations or to provide support for the baked goods after baking.

U.S. Pat. No. 4,431,395 issued to George B. Babos on Feb. 14, 1984 discloses a Gingerbread House Apparatus similar to the apparatus of the Green patent discussed immediately above. Again, the apparatus is used to bake the goods, as well as to form them prior to baking. The pans are removed prior to assembly of the three dimensional structure, however. One problem which is not addressed by any of the above prior art, is that of differential heat conduction of the various edge elements of the above devices. For example, it is noted that Babos provides for additional door and window cutouts, which cutting dies are baked along with the remainder of the baking apparatus. Cooking times and temperatures are generally devised to bake the majority of the goods uniformly, and it is recognized that exposed edges, or edges in contact with heated surfaces (e.g., a window cutout remaining in the dough during baking) will cause those portions of the goods to be overheated in comparison to the center. The present invention avoids this problem, by precluding use during the actual baking.

U.S. Pat. No. 4,452,419 issued to Burvelle E. Saleeba on Jun. 5, 1984 discloses a Modular Cake Pan including a plurality of inserts therefor which may be arranged as desired to form alphanumerical patterns. The cake batter is poured into the form and the form removed after baking, to provide a single baked good having an alphanumeric form. No means are provided for producing a plurality of baked goods which are assembleable into a completed whole, as with the present puzzle cookie cutter. Moreover, the device acts as a cooking or baking pan or container, with the goods remaining in the device during the baking process, unlike the present invention.

U.S. Pat. No. 4,943,063 issued to Claude R. M. Moreau on Jul. 24, 1990 discloses a Convertible Comestible comprising a plurality of molded edible pieces which may be assembled to form a three dimensional representation or model of an object. No mold, cutting die, or other forming means is disclosed, but the three dimensional shapes and the implication of molded goods, would preclude the use of cutting dies for the formation of the goods and would require the molds to be in place during the curing process, unlike the present invention.

U.S. Pat. No. 5,579,582, issued to Ethel G. Carlson on Dec. 3, 1996, discloses a puzzle cookie cutter having interchangeable dies for the cutting of cookie dough or the like, into a plurality of interlocking puzzle pieces. The pieces may then be baked conventionally, and distributed to children or other consumers. The consumers may reassemble the various cookie puzzle pieces to reform the pattern provided by the cutting die, prior to consuming the cookie puzzle. The interchangeable dies may have virtually any overall form, from simple geometric shapes, to animal and other caricatures of various sorts, to alphanumeric characters, if desired. The cookie puzzle pieces may be reassembled after baking for decoration, if desired, then disassembled before offering them to the consumer.

Finally, German Patent No. 2,703,900 to Gebr. Hack Feinbackwaren and published on Aug. 3, 1978 discloses a form for a gingerbread house or the like, similar to that produced using the Hartmann, Green or Babos devices discussed above. No interlocking shapes are disclosed, nor are any interchangeable cutting dies disclosed, as provided by the present invention.

### SUMMARY OF THE INVENTION

The present invention addresses the public's fascination with both food and puzzles, by providing puzzle candy that may be assembled in the mouth of the consumer to form structures of increased complexity. The puzzle candy comprises various pieces, which may assembled by manipulating them using the tongue, in combination with the walls and roof of the mouth. The puzzle candy may take numerous different shapes. One type includes a hoop and a ball. The ball may be passed through the hoop. Another includes a pair of annular pieces and a plug, which can be concentrically assembled. Another includes candy bolts and nuts. The nut is manipulated and rotated in order to engage the bolt. Another includes a sardine-can-shaped base member having a pair of apertures into which a pair of plugs may be inserted. Still another includes a double-cross male piece which fits into a mating socket in a female piece to form a rectangular solid block. Yet another includes a cross-shaped male piece having a square central plug which fits into a mating female socket piece to form a cubic shaped block. Still another is a dumbbell assembly formed from two identical end pieces which mate to a shaft piece. Finally, another includes a candy spring and candy washer which can be threaded onto the spring.

### DESCRIPTION OF THE DRAWINGS

FIG. 1 is an isometric view of a pair of annular pieces and a plug, which may be concentrically assembled;

FIG. 2 is an isometric view of a hoop-shaped piece and a ball-shaped piece;

FIG. 3 is an isometric piece of threadably engageable candy bolt and nut pieces;

FIG. 4 is an isometric view of a sardine-can-shaped base member having a pair of apertures, and two plug-shaped pieces which may be inserted into the apertures;

FIG. 5 is an isometric view of a double-cross male piece which fits into a mating socket in a female piece to form a rectangular solid block; and

FIG. 6 is a set of three pieces which may be assembled into a dumbbell-shaped structure;

FIG. 7 is an isometric view of a cross-shaped male member and a female member having a cross-shaped receptable;

FIG. 8 is an isometric view of a spring-shaped piece on to which a washer-shaped piece may be threaded;

FIG. 9 is an isometric view of the spring-shaped piece aand the washer-shaped piece of FIG. 4 after assembly;

### DETAILED DESCRIPTION OF THE INVENTION

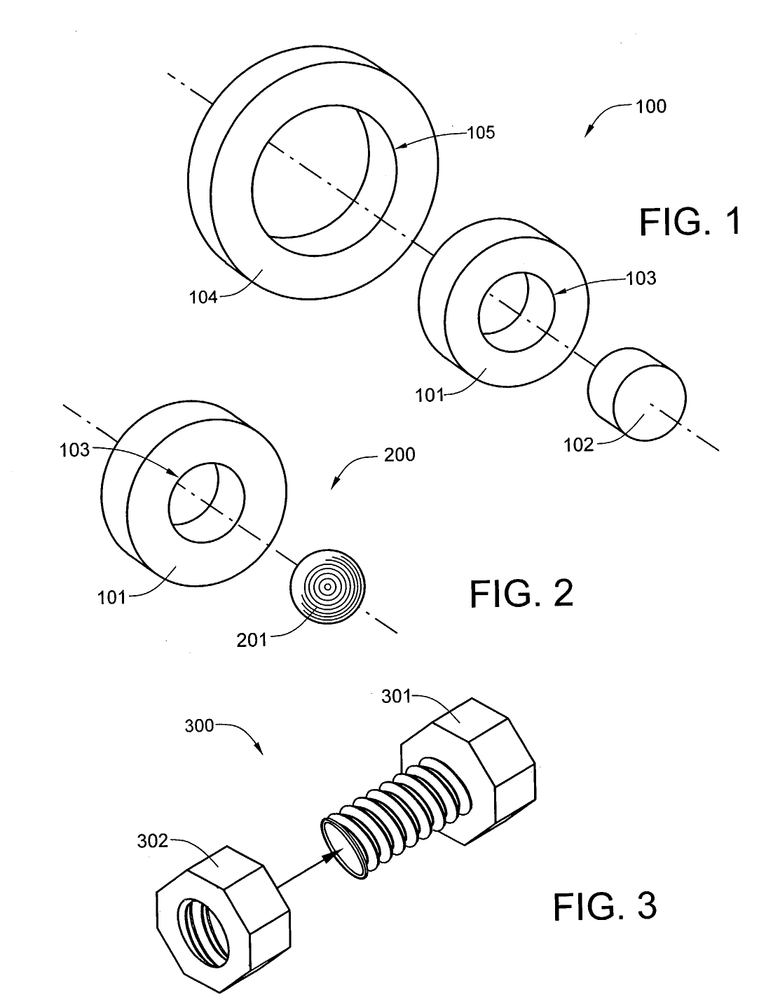

This invention provides for various embodiments of puzzle candy, the pieces of which may be assembled in the mouth of the consumer to form structures of increased complexity. In order to manipulate the various pieces of the puzzle, the consumer may use his tongue, in combination with the walls and roof of the mouth, thereby selectively moving and rotating the pieces, so that they may be assembled by feel. Of course, the individual pieces must be sized so that two or more pieces may be simultaneously contained in the mouth, with sufficient room to manipulate the various pieces as needed. A number of embodiments will now be described in detail with reference to the drawing FIGS. 1 through 9. It is contemplated that either generally inflexible hard sugar candy or semi-flexible, gelatin-containing sugared candy, having the composition of Jujubees®, for example, be used for the individual pieces of any of the various embodiments.

Referring now to FIG. 1, a first embodiment puzzle candy 100 comprises a first annular piece 101, a cylindrically-shaped plug piece 102, which is sized to fit within the aperture 103 of the first annular piece 101, and a second annular piece 104, which has an aperture 105 that is sized to receive the first annular piece 101. It is contemplated that the first annular piece 101 is about the same size as, or up to about 25 percent larger than, a piece of LifeSavers® candy.

Referring now to FIG. 2, a second embodiment puzzle candy 200 is similar to the first embodiment puzzle candy, with the exception that a ball-shaped piece 201 is used instead of the plug-shaped piece 102. The ball-shaped piece 201 is sized to fit through the aperture 103.

Referring now to FIG. 3, a third embodiment puzzle candy 300 includes a candy bolt 301 and nut 302. An ideal size for the threaded shank of the bolt portion 301 is deemed to be about 0.375 inch (0.95 cm). Because hard sugar candy dissolves rather rapidly, a relatively coarse thread should be used (i.e., nor more than about 13 per inch or 5 per cm).

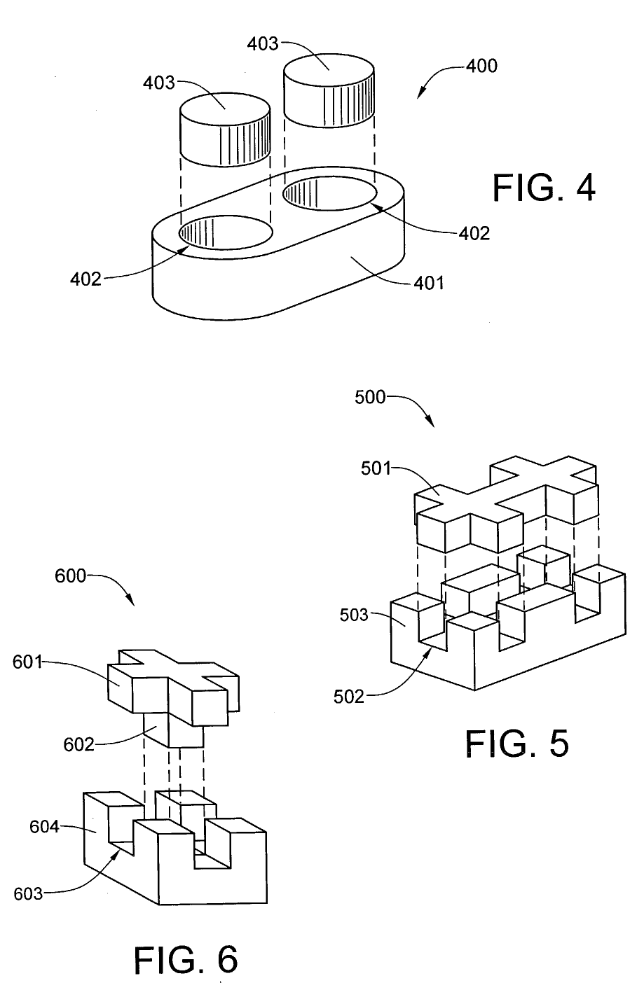

Referring now to FIG. 4, a fourth embodiment puzzle candy 400 includes a sardine-can-shaped base member 401 having a pair of apertures 402 into which a pair of plugs 403 may be inserted.

Referring now to FIG. 5, a fifth embodiment puzzle candy 500 includes a double-cross male piece 501 which fits into a mating socket 502 in a female piece 503 to form a rectangular solid block.

Referring now to FIG. 6, a sixth embodiment puzzle candy 600 includes a cross-shaped male piece 601 having a square central plug 602 which fits into a mating socket 603 within a female piece 604 to form a cubic shaped block.

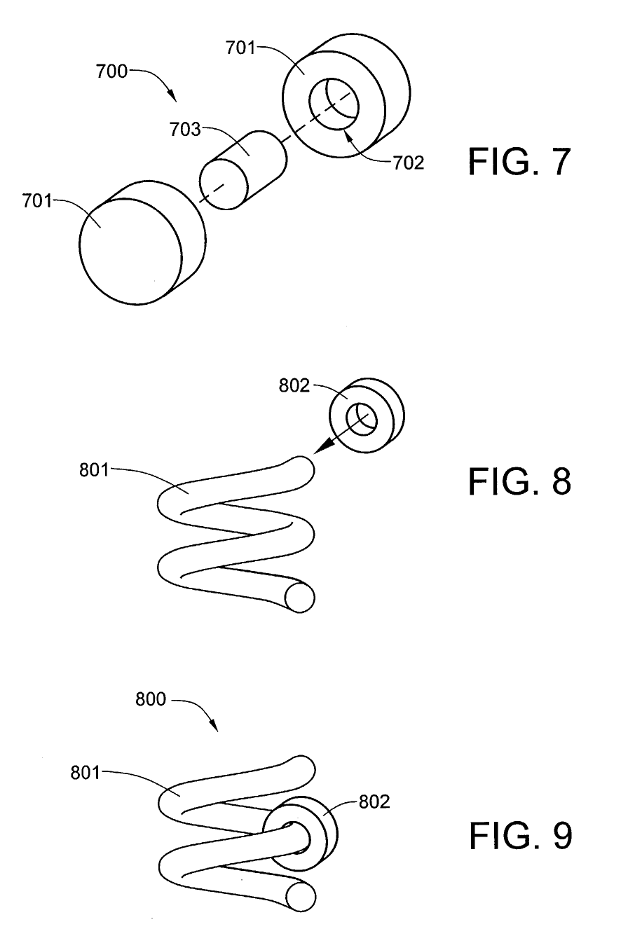

Referring now to FIG. 7, a seventh embodiment puzzle candy 700 includes a pair of identical end pieces 701, each of which has an aperture 702 into which one end of a shaft piece 703 may be inserted to couple the two end pieces 701.

Referring now to FIG. 8, an eighth embodiment puzzle candy 800 includes a candy spring 801 and a donut-shaped or washer-shaped piece 802, which can be threaded onto the spring. In this drawing figure, the two pieces 801 and 802 are shown unassembled.

Referring now to FIG. 9, the fourth embodiment puzzle candy 800 is shown in an assembled state, with the donut-shaped piece 802 having been slid over the spring-shaped piece 801.

Although only several embodiments of the invention have been heretofore described, it will be obvious to those having ordinary skill in the art that many different types of candy puzzles that can be assembled within a consumer's mouth may be devised, and that changes and modifications may be made to the existing examples without departing from the scope and the spirit of the invention as hereinafter claimed.

What is claimed is:

1. A puzzle comprising a set of at least two pieces of candy, all of which are small enough to be simultaneously contained within the mouth of a consumer, and each of which is large enough so that it can be manipulated by the tongue, in combination with the walls and roof of the mouth, so that the pieces may be assembled into a single, more complex structure.

2. The puzzle of claim 1, wherein the set comprises at least one annular piece having a central aperture, and a generally spherical piece insertable through the central aperture.

3. The puzzle of claim 1, wherein the set comprises at least one annular piece having a central aperture, and a cylindrically-shaped plug piece insertable through the aperture.

4. The puzzle of claim 3, wherein the set comprises two annular pieces and all pieces are concentrically assembleable into a single unit.

5. The puzzle of claim 1, wherein the set comprises a male-threaded screw piece and a female-threaded nut piece.

6. The puzzle of claim 1, wherein the set comprises a sardine-can-shaped member, having a pair of apertures, and a pair of plugs, each of which may be inserted into an aperture.

7. The puzzle of claim 1, wherein the set comprises a double-cross male piece which fits into a mating socket in a female piece to form a rectangular solid block.

8. The puzzle of claim 1, wherein the set comprises a cross-shaped male piece having a square central plug, which fits into a mating socket within a female piece to form a generally cubic shaped block.

9. The puzzle of claim 1, wherein the set comprises two identical end pieces, each of which has a cylindrical recess, and a cylindrical shaft piece, each end of which may be inserted into a cylindrical recess to form a dumbbell-shaped structure.

10. The puzzle of claim 1, wherein the set comrpises a spring-shaped piece and a doughnut-shaped piece, which can be slipped onto the spring-shaped piece.

11. A puzzle comprising a set of at least two pieces of candy, all of which are assemblable in the mouth of a consumer, by manipulation of the pieces with the tongue, into a more complex assembled structure.

12. The puzzle of claim 11, wherein the set comprises at least one annular piece having a central aperture, and a generally spherical piece insertable through the central aperture.

13. The puzzle of claim 11, wherein the set comprises two annular pieces, each having an associated central aperture, the central aperture of one having a diameter about equal to the outer diameter of the other, and a cylindrically-shaped plug piece insertable through the aperture of the smaller of the two annular pieces.

14. The puzzle of claim 11, wherein the set comprises a male-threaded screw piece and a female-threaded nut piece.

15. The puzzle of claim 11, wherein the set comprises a sardine-can-shaped member, having a pair of apertures, and a pair of plugs, each of which may be inserted into an aperture.

16. The puzzle of claim 11, wherein the set comprises a double-cross male piece which fits into a mating socket in a female piece to form a rectangular solid block.

17. The puzzle of claim 11, wherein the set comprises a cross-shaped male piece having a square central plug, which fits into a mating socket within a female piece to form a generally cubic shaped block.

18. The puzzle of claim 11, wherein the set comprises two identical end pieces, each of which has a cylindrical recess, and a cylindrical shaft piece, each end of which may be inserted into a cylindrical recess to form a dumbbell-shaped structure.

19. The puzzle of claim 11, wherein the set comrpises a spring-shaped piece and a doughnut-shaped piece, which can be slipped onto the spring-shaped piece, a donut-shaped piece having a central aperture, and a ball piece insertable through the aperture.

20. A method of consuming candy comprising the steps of:
providing a set of at least two individual pieces of candy, all of which are small enough to be simultaneously contained within the mouth of a consumer;
inserting them in the mouth;
manipulating the individual pieces with the tongue in order to fit the pieces together into a more complex structure.
